(19) United States
(12) Patent Application Publication
(10) Pub. No.: US 2005/0160426 A1
(43) Pub. Date: Jul. 21, 2005

(54) Method for adjusting a user interface in a pre-press workflow system

(76) Inventor: Wim Helsen, Herentals (BE)

Correspondence Address: Robert A Sabourin;Agfa Corporation, Patent Department, 200 Ballardvale Street, Wilmington, MA, 01069, US

(21) Appl. No.: 10/505,464

(22) PCT Filed: Feb. 25, 2003
(86) PCT No.: PCT/EP03/50033

Related U.S. Application Data
(60) Provisional application No. 60/373,477, filed on Apr. 18, 2002.

(30) Foreign Application Priority Data
Feb. 28, 2002 (EP) 02100202.7

(51) Int. Cl. G06F 9/46

(52) U.S. Cl. 718/100

(57) ABSTRACT

A method for adjusting a user interface for processing a job in a pre-press workflow system includes the steps of (a) checking the type of the job and (b) automatically adjusting the user interface, depending on the type of the job.

### FIELD OF THE INVENTION

The invention relates to the field of pre-press workflow systems, in particular to a user interface in such systems.

### BACKGROUND OF THE INVENTION

A user interface (UI) is a means that allows a user to interact with a computer. A user interface may be implemented by means of a computer program, running on a computer that is connected to a display. The user can then interact with the computer, typically by using a mouse to make choices from menus or groups of icons shown on the display.

The user interface of pre-press workflow software gives dedicated information about jobs under control of the pre-press workflow system (a job means the processing of a set of document pages according to specific instructions). This user interface may have several functions. It may indicate the job status, i.e. what the job is doing, what pre-press task it is performing. Parameters of the different jobs may be set and changed. It is possible to add, change or remove system-wide parameters (e.g. fonts, calibration curves). Intermediate results and previews may be shown.

In prior art pre-press workflow software, the UI layout is static, so that although parameters change, the visual representation of these parameters stays the same.

A pre-press workflow system, as disclosed in patent application WO 01/25907, uses such a user interface.

There is still a need for an improved system and method for interacting with a computer in a pre-press workflow system.

### SUMMARY OF THE INVENTION

The present invention is a method for adjusting a user interface for processing a job in a pre-press workflow system as claimed in independent claim 1. Preferred embodiments of the invention are set out in the dependent claims. Preferably, a method in accordance with the invention is implemented by a computer program as claimed in claim 11.

In the present invention, the UI representation of a pre-press workflow management system is automatically adjusted according to the type of job that is processed. The same software version contains different UI representations for different application areas (or market segments) such as for the packaging printing industry and for the commercial printing industry. The correct UI representation for a given application area is automatically visualized by the software, depending on the type of job.

This is opposed to prior art pre-press software for different market segments, wherein the software is compiled for each specific market segment, so that there is a different software version for each different market segment. Each of these software versions uses a dedicated UI representation, that is fixed for all jobs entering the system. The different software versions each have a different UI representation, that depends on the target market.

An advantage of the invention is that only a single software product is required, instead of different software versions for different market segments.

In the invention, the type of job that is processed is checked, and the user interface of the workflow management system is adjusted automatically, depending on the job type. The UI is thus context based. An advantage is that jobs of different types (e.g. for commercial printing and for packaging) can go through the workflow system at the same time, with different UI representations.

Further advantages and embodiments of the present invention will become apparent from the following description.

### DETAILED DESCRIPTION OF THE INVENTION

In the invention, the job itself defines the UI, preferably via one or more settings. This can be realized in different ways, as follows.

In a first embodiment of the invention, the type of job is determined by checking the origin of input data for the job. If input data defining a document for the job originate from a software package oriented towards a specific market segment (such as e.g. the software package Preps™ from ScenicSoft, which is an imposition package for the commercial printing market segment) then it is assumed that the job type is this specific market segment. A parameter in the job that is generated is set, defining the job type (e.g. “commercial printing”). The job type is thus defined within the job. Later, in a subsequent step, the job type is checked by reading this parameter, and the user interface is then adjusted in accordance with the job type. Setting this parameter within the job, in the preceding step, may be done by means of so-called input channels of the workflow system, that are an input mechanism to bring data, such as a document, into the workflow system; input channels are used in Agfa's Apogee™ workflow software products. For example, when data is received by an input channel of the workflow system, the input channel may generate a job and set a parameter to define the job type, which will subsequently define the correct UI representation. Different input channels may be used for data related to different job types, so that a particular input channel is only used for one type of jobs (such as commercial printing). The particular input channel then sets a parameter that defines the job type, which will subsequently define the UI representation.

In a second embodiment of the invention, the pre-press workflow software checks one or more characteristics of data related to a job to determine the job type. If the data contain e.g. a step-and-repeat instruction, the job is assumed to be a packaging type job, whereas the presence of pages points to a job for commercial printing.

In a third embodiment of the invention, the user defines the job type, e.g. initially, during the job definition; the thus defined job type is then stored. In a subsequent step, the stored job type is checked, and the user interface is adjusted based on the job type.

These embodiments illustrate how, in the present invention, the UI is defined by the job itself.

In another embodiment of the invention, when creating a new type of job, the user defines the correct UI representation for this type of job.

The UI representation of the workflow management system is adjusted automatically, depending on the type of job that is processed. The adjustment may include the layout of the user interface. The adjustment may include the use of the appropriate terminology and/or parameter settings for the market segment of the job. This is very convenient to the user.

For example, different terminology may be used in different printing markets. Because people are used to working with their own terminology, it even happens that in different printing markets different terms mean the same feature or functionality. In the commercial printing industry, for example, the width of printed pages is expressed in the number of pages, and terms as 4-up and 8-up are used. In the packaging printing industry, on the other hand, no page indications are used, but terms as narrow web and wide web are used.

An example of a parameter setting for the market segment of the job (or, in general, for the job type) is the following. Depending on the job type, a parameter is set in order to display a list of halftone screens especially suited for the job type. For packaging, a list of halftone screens suited for flexographic printing will be displayed, while for commercial printing, the list will contain halftone screens suited for offset printing. Thus, in general, a parameter for the job type is set, and, depending on this parameter, specific data are displayed in the user interface.

Preferably, pre-press workflow software in accordance with the invention dynamically switches the UI between jobs for different market segments, such as commercial printing and packaging. Such jobs for different market segments may therefore be handled in any order by the same software product.

Another advantage of the invention is that the different UI representations have no influence on the speed or timing of the processing of the jobs.

Having described in detail preferred embodiments of the current invention, it will now be apparent to those skilled in the art that numerous modifications can be made therein without departing from the scope of the invention as defined in the appending claims.

1. A method for adjusting a user interface for processing a job in a pre-press workflow system, the method comprising:
checking a job type of said job; and
automatically adjusting said user interface depending on said job type.

2. The method according to claim 1 wherein step of checking a job type comprises checking a job type of said job in the commercial printing industry or the packaging printing industry.

3. The method according to claim 1 further comprising the step of:
automatically adjusting a layout of said user interface depending on said job type.

4. The method according to claim 1 further comprising the step of:
automatically adjusting an appropriate terminology for said job type in said user interface.

5. The method according to claim 1 further comprising the steps of:
setting a parameter for said job type; and
displaying specific data in said user interface depending on said parameter.

6. The method according to claim 1 further comprising the steps of:
receiving input data for said job;
checking an origin of said input data; and
determining said job type based on said origin.

7. The method according to claim 1 further comprising the steps of:
checking a characteristic of data related to said job; and
determining said job type based on said characteristic.

8. The method according to claim 1 further comprising the steps of:
determining said job type by a user; and
storing said determined job type wherein said storing step precedes said step of checking said job type.

9. The method according to claim 1 further comprising the steps of:
creating a new job type; and
defining a new user interface by a user for processing jobs of said new job type in said pre-press workflow system.

10. A data processing system comprising means for carrying out the steps of the method according to claim 1.

11. A computer program comprising computer program code means adapted to perform the steps of the method according to claim 1 when said program is run on a computer.

12. A computer readable medium comprising program code adapted to carry out the method according to claim 1 when run on a computer.

13. A computer program product for adjusting a user interface for processing a job in a pre-press workflow system, the computer program product comprising:
first program instructions for checking a job type of said job;
second program instructions for automatically adjusting said user interface depending on said job type.

14. The computer program product of claim 13 wherein said job type is for application in the commercial printing industry or the packaging printing industry.

15. The computer program product of claim 13 further comprising a computer readable medium wherein said first and second program instructions are recorded on said medium.

16. The computer program product of claim 13 further comprising third program instructions for automatically adjusting a layout of said user interface depending on said job type.

17. The computer program product of claim 16 further comprising fourth program instructions for automatically adjusting an appropriate terminology for said job type in said user interface.

18. The computer program product of claim 17 further comprising:
fifth program instruction for receiving input data for said job;
sixth program instructions for checking an origin of said input data; and
seventh program instructions for determining said job type based on said origin.
